(19) United States
(12) Patent Application Publication
(10) Pub. No.: US 2024/0285461 A1
(43) Pub. Date: Aug. 29, 2024

(54) A knee movement assistive device

(71) Applicants: Fondazione Istituto Italiano di Tecnologia, Genova GE (IT); Università Degli Studi Di Genova, Genova (IT)

(72) Inventors: Yifang ZHANG, Genova GE (IT); Nikolaos TSAGARAKIS, Genova GE (IT); Arash AJOUDANI, Genova GE (IT)

(21) Appl. No.: 18/569,641

(22) PCT Filed: May 27, 2022
(86) PCT No.: PCT/IB2022/055012

§ 371 Date: Dec. 13, 2023

(30) Foreign Application Priority Data
Jun. 15, 2021 (IT) 102021000015641

(51) Int. Cl. A61H 1/02

(52) U.S. Cl. CPC A61H 1/0255; A61H 2201/1215; A61H 2201/1261; A61H 2201/1628; A61H 2201/1642; A61H 2201/165; A61H 2203/0412

(57) ABSTRACT

A knee movement assistive device (1), comprising: a waist garment (2) attachable to a user waist and a calf garment (3) attachable to a user calf; an actuator (4) attached to the waist garment (2) and comprising a driver (41; a transmission cable (5) connecting the actuator (4) to the calf garment (3); a chain (7) comprising a modular body (71) having a fixed end (72), attached to the calf garment (3) and a free end (73) and comprising a groove (75) defined on the upper surface (74), the transmission cable (5) being slidably channeled in the groove (75).

The project leading to this application has received funding from the European Union's Horizon 2020 research and innovation programme under grant agreement No 871237.

### TECHNICAL FIELD

The present invention is related to a knee movement assistive device. Said assistive device is particularly useful in assisting the knee movement of a user undergoing rehabilitation therapy. For example, said assistive device is particularly useful in assisting a user performing a squat.

### STATE OF THE ART

It is known in the art a knee movement assistive device comprising a waist garment attachable to a user waist and a calf garment attachable to a user calf.

The known assistive device comprises an actuator attached to the waist garment and comprising a driver. Said driver is configured to switch between an active state, wherein the driver generates an actuation force, and an idle state, wherein the driver generates a null force.

In addition, the known assistive device comprises a transmission cable connecting the actuator to the calf garment and being configured to transmit the actuation force, generated by the driver, to the calf garment.

The actuation force transmitted to the calf garment assist the knee movement, for example, reducing the knee torque when the user is performing a squat.

### Problem of the Prior Art

However, it is known that during the movement performed by a user wearing the known assistive device, undesired forces generated by the known assistive device act directly on the knee joint.

These forces interferes with the movement of the users, causing high discomfort for the user wearing the known assistive device. At the same time, said forces induce the user performing wrong movements, invalidating the rehabilitation exercise performed by the user.

### SCOPE OF THE INVENTION

In this context, the technical object of the present invention is to provide a knee movement assistive device which overcomes the drawbacks of the prior art.

Namely, the object of the present invention is to provide a stable knee movement assistive device that guarantee high comfort to the user wearing said assistive device.

The specifically technical object and the specified aims are substantially achieved by a knee movement assistive device comprising the technical characteristics described in one or more of the appended claims.

### Advantages of the Invention

The knee movement assistive device described allows correctly assisting a user knee movement, guaranteeing high comfort to the user wearing said assistive device.

At the same time, the knee movement assistive device described reduces the risk of incorrect movements performed by the user wearing the assistive device.

### BRIEF DESCRIPTION OF THE DRAWINGS

Further characteristics and advantages of the present invention will appear more clearly for the description of a preferred embodiment of a knee movement assistive device as illustrated in the enclosed drawings in which:

FIG. 1 is a front view of a user wearing a knee movement assistive device according to the present invention;

FIG. 2 is a front view of the assistive device of FIG. 1;

FIG. 3 is a lateral view of the assistive device of FIG. 1;

FIG. 4 is a back view of the assistive device of FIG. 1;

FIG. 5 is a perspective view of an actuator of the assistive device of FIG. 1;

FIG. 6 is a perspective view of a detail of the actuator of FIG. 5;

FIG. 7 is a front view of the detail of FIG. 6;

FIG. 8 is a lateral view showing a chain and a calf garment of the assistive device of FIG. 1;

FIG. 9 is a perspective view of the chain and of the calf garment of FIG. 8;

FIG. 10 is a perspective view of a detail of the chain of FIG. 7 and FIG. 8;

FIG. 11 is a lateral view of the detail of FIG. 10;

FIG. 12 is a back view of a detail of the assistive device of FIG. 1;

FIG. 13 is a front view of a detail of the assistive device of FIG. 1;

FIG. 14 is a front view of a support element of the assistive device of FIG. 1;

FIG. 15 is a perspective view of an alternative embodiment of a detail of the support element of FIG. 14;

FIG. 16 shows a front and a back view of an alternative embodiment of the assistive device of FIG. 1;

FIG. 17 shows two lateral views of the assistive device of FIG. 16.

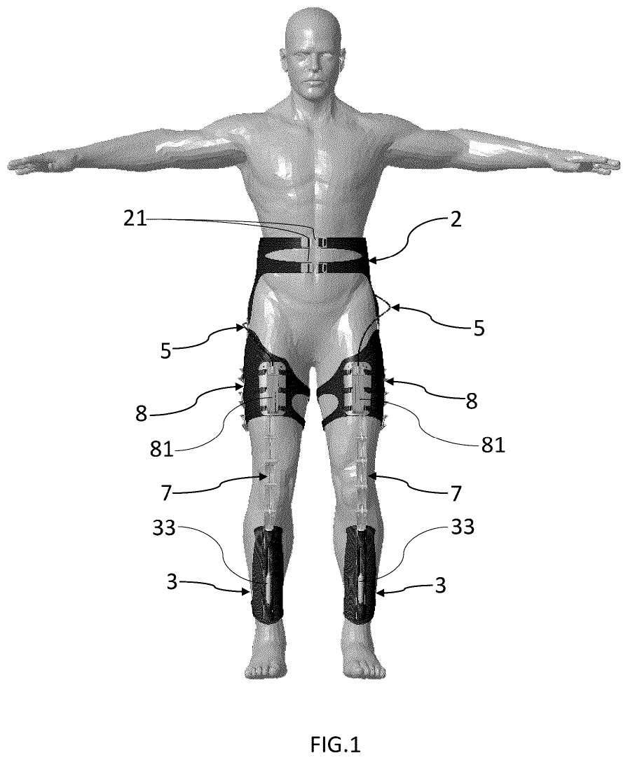

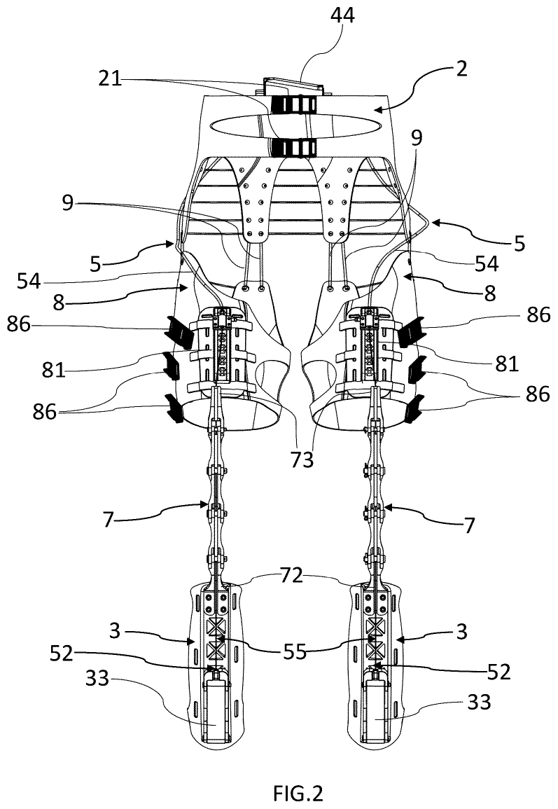

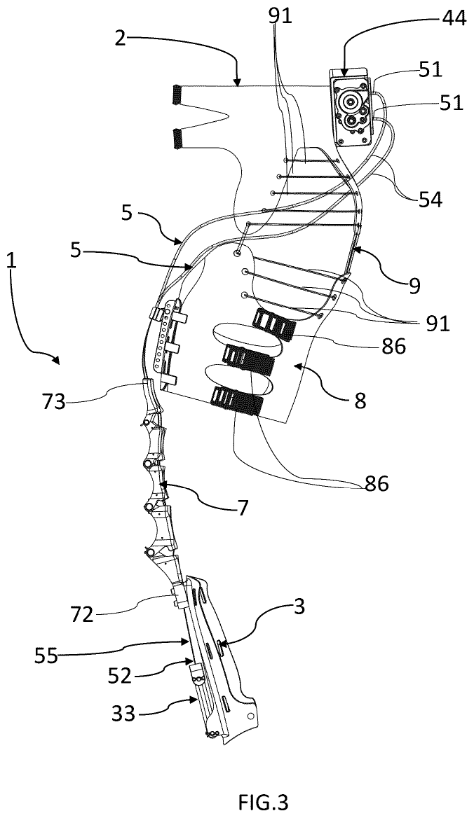

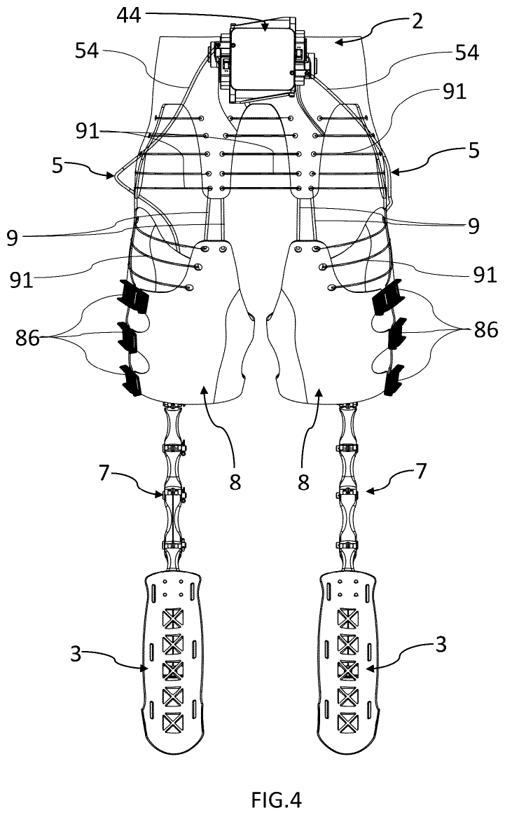

### DETAILED DESCRIPTION

With reference to the attached figures, numeral 1 designates a knee movement assistive device.

The assistive device 1 comprises a waist garment 2 attachable to a user waist. For example, the waist garment 2 comprises at least one first buckle 21. Preferably, the waist garment 2 comprises a couple of first buckles 21. As is per se know to the skilled person, the first buckles 21 allows the waist garment 2 to be stably attached to a user waist. At the same time, the first buckles 21 allows to adjust the waist garment 2 according to the specific dimension of the user waist, increasing the comfort of the user wearing said waist garment 2.

In addition, the assistive device 1 comprises a calf garment 3 attachable to a user calf. For example, the calf garment 3 comprises a couple of joint portions 36. The joint portion 36 can be clamped to a user calf, stably attaching the calf garment 3 to the user calf.

The calf garment 3 is arranged along a longitudinal direction X-X. When the calf garment 3 is attached to a user calf, preferably, the longitudinal direction X-X overlaps to the direction defined by the user calf. Alternatively, when the calf garment 3 is attached to a user calf, the longitudinal direction X-X defines a small relative angle with respect to the direction defined by the user calf.

The assistive device 1 comprises an actuator 4 attached to the waist garment 2 and comprising a driver 41. When the waist garment 2 is attached to a user waist, the actuator 4 is preferably arranged on a back side of the user. As it is known to the skilled person, the back side of the user is the one defined by the back of the user.

Accordingly, the driver 41 is configured to switch between an active state, wherein the driver 41 generates a rotational force, and an idle state, wherein the driver 41 generates a null force. In other words, in the idle state the driver 41 generates no rotational force.

The actuator 4 is configured to transform the rotational force of the driver 41 in a tension force.

According to a preferred feature, the assistive device comprises rechargeable battery being configured to supply power to the driver 41.

Preferably, the assistive device 1 comprises a box 44. The driver 41 and the rechargeable battery are arranged inside the box 44. Also the box 44 is arranged on the back side of a user wearing the assistive device 1.

In addition, the assistive device 1 comprises a transmission cable 5 connecting the actuator 4 to the calf garment 3 and being configured to transmit the tension force, generated by transforming the rotational force of the driver 41, to the calf garment 3. The tension force transmitted to the calf garment 3 assist the knee movement of a user. For example, the tension force, generated by transforming the rotational force of the driver 41 and transmitted to the calf garment 3, provide assistive torque to the knee joint when the user is bending the knee.

Preferably, the transmission cable 5 has an upper end 51 connected to the actuator 4 and a lower end 52 connected to the calf garment 3. Still preferably, the transmission cable 5 corresponds to a Bowden cable.

Still preferably, the transmission cable 5 comprises a cover housing 54 and inner cable 55 at least in part slidably channeled in the cover housing 54.

According to the preferred embodiment of the invention, the actuator 4 comprises a first gear 42 connected to the driver 41 and being configured to rotate around a first rotation center. The rotational force generated by the driver 41 makes the first gear 42 rotate around the first rotation center. In other words, when the driver 41 is in the active state the first gear 42 rotates around the first rotation center.

Still according to the preferred embodiment of the invention, the actuator 4 comprises a second gear 43 operatively engaging the first gear 42 and being configured to rotate around a second rotation center. The transmission cable 5 is connected to the second gear 43. For example, the actuator 4 comprises a pulley 45 connected to the second gear 43 and the inner cable 55 of the transmission cable 5 is connected to the pulley 45.

According to the preferred embodiment of the invention, the actuator 4 comprises locking means 6 operatively engaging the first 42 and the second 43 gears.

Preferably, the first gear 42, the second gear 43 and the locking means 6 are mounted on a sidewall 441 of the box 44.

According to a preferred feature, the locking means 6 are configured to switch between a locking configuration and a releasing configuration.

Preferably, In the locking configuration of the locking means 6, the second gear 43 is prevented to rotate around the second rotation center.

Still preferably, in the releasing configuration of the locking means 6, the rotation of the first gear 42 makes the second gear 43 rotate around the second rotation center so that the rotational force generated by the driver 41 is transformed in the tension force and can be transmitted to the calf garment 3 through the transmission cable 5. In fact, being the inner cable 55 of the transmission cable 5 attached to the second gear 43, the rotation of the second gear 43 pulls the transmission cable 5 or release the pull action on the transmission cable 5. In other words, depending on the specific rotation direction of the second gear 43, the rotational force of the driver 41 is transformed in a first tension force acting as pull force or in a second tension force acting as a releasing force. The second tension force progressively release the first tension force, namely release the pull action transmitted to the calf garment 3. In other words, the second tension force is opposite to the first tension force.

Still preferably, the locking means 6 are configured to switch from the locking configuration to the releasing configuration due to the rotation of the first gear 42 when the driver 41 is in the active state. Therefore, when the driver 41 is in the active state, the tension force can be transmitted to the calf garment 3 to assist the user knee movement.

Still preferably, the locking means 6 are configured to automatically switch from the releasing configuration to the locking configuration when the driver 41 is switched to the idle state. Therefore, when the driver 41 is switched to the idle state, being the locking means 6 in the locking configuration, the tension force generated from the rotational force of the driver 41 is still transmitted to the calf garment 3, without needing to maintain the driver 41 in the active state. In other words, after the desired tension force has been transmitted to the calf garment 3, the driver 41 can be switched to the idle state letting the desired tension force still act on the calf garment 3.

As a result, after the desired tension force is transmitted to the calf garment 3, the driver 41 can be switched to the idle state continuing assisting the user knee movement and reducing, therefore, the overall energy needed to assist the user knee movement with the assistive device 1.

According to a preferred embodiment of the invention, the first gear 42 has a first perimetral wall 421, arranged on a first circumferential direction. Namely, the first gear 41 has a circular shape.

In addition, the first gear 42 has a plurality of first teeth 422 arranged on said first perimetral wall 421. Preferably, the firs teeth 422 are equally spaced apart from each other along the first circumferential direction. The rotation of the first gear 42 around the first rotation center making the first teeth 422 move along the first circumferential direction. In other words, when the driver 41 is in the active state, the first teeth 422 move along the first circumferential direction.

Preferably, the first teeth 422 has a wedge shape. Still preferably, the first gear 42 has fifteen first teeth 422.

Still according to the preferred embodiment of the invention, the second gear 43 has a second perimetral wall 431, arranged on a second circumferential direction. Namely, also the second gear 43 has a circular shape.

In addition, the second gear 43 has a plurality of second teeth 432 arranged on the second perimetral wall 431. Preferably, the second teeth 432 are equally spaced apart from each other along the second circumferential direction. The rotation of second gear 43 around the second rotation center making the second teeth 432 move along the second circumferential direction.

Preferably, the second gear 43 has twenty-five second teeth 432.

Accordingly, the rotation of the first gear 42 in the releasing configuration of the locking means 6 makes each first tooth 422 progressively engage a respective second tooth 432 making the second gear 43 rotate around the second rotation center.

Still preferably, the first gear 42 is configured to clockwise and anticlockwise rotate due to the rotational force generated by the driver 41. It should be noted that, due to the progressively engagement of each first tooth 422 with a respective second tooth 432, the clockwise rotation of the first gear 42 is transformed in an anticlockwise rotation of the second gear 43, while the anticlockwise rotation of the first gear 42 is transformed in a clockwise rotation of the second gear 43. Namely, the rotation direction of the first gear 42 is preferably opposite to the rotation direction of the second gear 43.

It should be noted that, for example, an anticlockwise rotation of the second gear 43 transformed the rotational force of the driver 41 in the first tension force, pulling the transmission cable 5, while a clockwise rotation of the second gear 43 transform the rotational force of the driver 41 in the second tension force, releasing the pull action on the transmission cable 5.

According to a preferred feature, each couple of second teeth 432 is spaced apart by a respective separation distance along the second circumferential direction. Said separation distance is greater than the thickness of each first tooth 422 along the first circumferential direction.

Given that the separation distance is greater than the thickness of each first tooth 422, at least one first tooth 422 is interposed between a couple of second teeth 432 and is spaced apart from each of said second teeth 432 in the locking configuration of the locking means 6. The rotational force of the driver 41 makes said first tooth 422 engaging one of said second teeth 432.

Therefore, before at least one first tooth 422 engages a second tooth 432, the rotation of the first gear 42, due to the rotational force of the driver 41, switches the locking means 6 from the locking configuration to the releasing configuration. Namely, the locking means 6 are switched from the locking configuration to the releasing configuration before the first gear 42 makes the second gear 43 to rotate around the second rotation center. In this way, no rotation of the second gear 43 occurs when the locking means 6 are in the locking configuration.

According to the preferred embodiment of the invention, the locking means 6 comprises a stopper 61 having a first engagement portion 611. Preferably, the first engagement portion 611 has a tip shape.

The stopper 61 is configured to assume in the locking configuration of the locking means 6 a locking position, wherein the first engagement portion 611 engages at least one second tooth 432. Preferably, in the locking position, the first engagement portion 611 is inserted between a couple of second teeth 432. Therefore, when the stopper 61 is in the locking position the second gear 43 cannot rotate around the second rotation center.

At the same time, the stopper 61 is configured to assume in the releasing configuration of the locking means 6 a releasing position, wherein the first engagement portion 611 is spaced apart from the second gear 43 along a direction transverse to the second circumferential direction. It should be noted that, when the locking means 6 are in the releasing configuration the stopper 61 is almost always in the releasing position so that the second gear 43 can rotate around the second rotation center without risking that a second tooth 432 engages the first engagement portion 611. However, it could happen that in the releasing configuration of the locking means 6 a second tooth 432 hits the first engagement portion 611, but without stopping the rotation of the second gear 43.

Preferably, the locking means 6 is configured to assume an intermediate configuration between the releasing configuration and the locking configuration. In said intermediate configuration, the engagement portion 611 of the stopper 61 is inserted between a couple of second teeth 432 and is spaced apart from said second teeth 432. The passive clockwise rotation of the second gear 43 when the locking means 6 are in the intermediate configuration and the driver 41 is in the idle state makes at least one second tooth 432 engage the first engagement portion of the stopper 611, switching the locking means 6 in the locking configuration, locking the rotation of the second gear 43.

According to the preferred embodiment of the invention, the locking means 6 comprises a lever 62. The lever 62 is configured to rotate around a third rotation center.

The lever 62 extends between a second engagement portion 621 and an opposite thrust portion 622 along an axis of the lever 62 passing through the third rotation center. Preferably, the thrust portion 622 has a tip shape.

The thrust portion 622 engages the stopper 61. Preferably, the thrust portion 622 engages a receiving portion 612 of the stopper 61.

It should be noted that, the rotation of the first gear 42 due to the rotational force of the driver 41 makes the first gear 42 to engage the lever 62 at the second engaging portion 621 to put the lever 62 in rotation around the third rotation center. At the same time, the rotation of the lever 62 around the third rotation center makes the thrust portion 622 exert a thrust action on the stopper 61 to switch the stopper 61 from the locking position to the releasing position. Namely, due to the rotation of the lever 62 the thrust portion 622 exerts a thrust action on the receiving portion 612 of the stopper 61, displacing the first engagement portion 611 away from the second gear 43.

When the driver 41 is switched to the idle state, namely when the first gear 42 stops rotating, the thrust portion 622 stops exerting a thrust action on the stopper 41, making the first engagement portion 611 to progressively approach the second gear 43. In other words, after the driver 41 is switched to the idle state, the locking means 6 can switch from the releasing configuration to the locking configuration or to the intermediate configuration and then to the locking configuration.

Preferably, the locking means 6 comprises a spring 63 acting on the stopper 61. The spring 63 makes the first engagement portion 611 to progressively engage the second gear 43, when the driver 41 is switched to the idle state. In fact, the spring 63 always exert a pushing action on the first engagement portion 611 pushing said first engagement portion 611 against the second gear 43. When the driver 41 is switched to the active state, the thrust action of the thrust portion 622 acting on the stopper 61 wins the pushing action of the spring 63, displacing the first engagement portion 611 away from the second gear 43. When, the driver 41 is switched to the idle state, the thrust portion 622 stops exerting a thrust action on the stopper 41, so that the pushing action of the spring 63 makes the first engagement portion 611 to progressively engage the second gear 43.

It should be noted that, preferably, the thrust portion 622 of the lever 62 remains in contact with the stopper 61 both when the locking means 6 are in the locking configuration and in the releasing configuration, but also during the switching of the locking means 6 between the locking configuration and the releasing configuration.

It should be noted that, during the rotation of the first gear 42, the first teeth 422 engages one by one the lever 62 at the second engagement portion 621, making the lever 62 to rotate around the third rotation center.

It should also be noted that, preferably, the clockwise rotation of the first gear 42 makes the first gear 42 engage the second engagement portion 621 in a first contact area to anticlockwise rotate the lever 62. Namely, the first teeth 422 engage the second engagement portion 621 in the first contact area.

At the same time, still preferably, the anticlockwise rotation of the first gear 42 makes the first gear 42 to engage the second engagement portion 621 in a second contact area to anticlockwise rotate the lever 62. Namely, the first teeth 422 engage the second engagement portion 621 in the second contact area.

Preferably, the rotation of the first gear 42 around the first rotation center makes always the lever 62 to anticlockwise rotate around the third rotation center so that the thrust portion 622 exert the thrust action on the stopper 61. Namely, when the driver 41 is in the active state, both the clockwise and the anticlockwise rotation of the first gear 42 switch the locking means 6 from the locking to the releasing configuration. In this way, the rotational force generated by the driver 41 in the active state is always transferred to the calf garment 3 in order to assist the knee movement, given that the second gear 43 can freely rotate around the second rotation center.

Preferably, the first contact area and second contact area are spaced apart from each other along the axes of the lever 62. Still preferably, the distance of the first contact area from the third rotation center along the axes of the lever 62 is smaller than the distance of the second contact area from the third rotation center along the axes of the lever 62.

According to the preferred embodiment of the invention, the second engagement portion 621 of the lever 62 has a curved edge 623 facing the first gear 42. The curved edge 623 has a recessed portion 624 and a rounded portion 625. Preferably, the first contact area is placed on the left side of the rounded portion 625, while the second contact area is placed on the right side of the rounded portion 625.

It should be noted that, preferably, the anticlockwise rotation of the lever 62 makes the stopper 61 to clockwise rotate around a fourth rotation center so that it is displaced from the locking position to the releasing position. Namely, following the rotation of the first gear 42 in the active state of driver 41, the stopper 61 clockwise rotate around the fourth rotation center. It should also be noted that, when the driver 41 is switched from the active state to the idle state, the stopper 61 automatically anticlockwise rotates around the fourth rotation center so that the locking means 6 can be switched from the releasing configuration to the intermediate configuration or to the locking configuration.

Preferably, the first engagement portion 611 and the receiving portion 612 of the stopper 61 are opposite to each other with respect to the fourth rotation center.

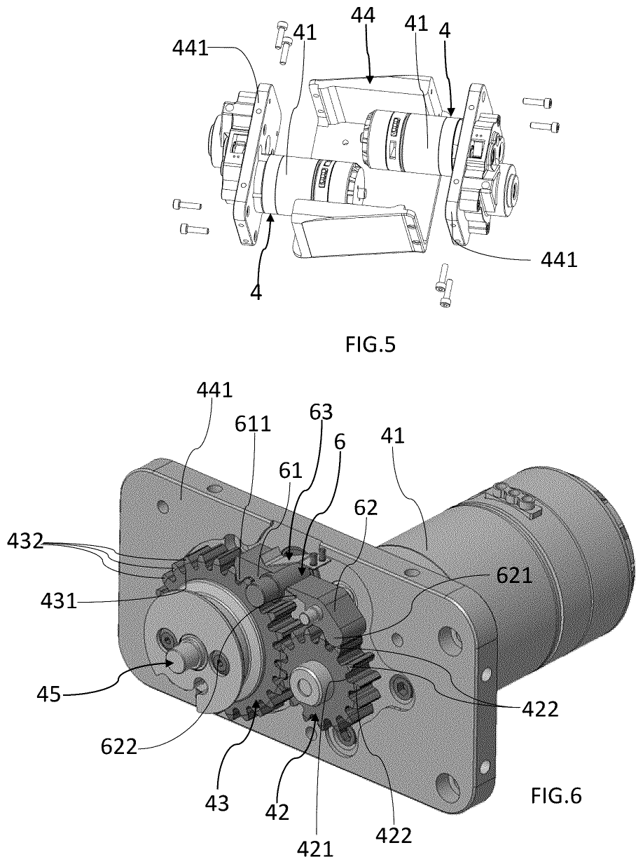

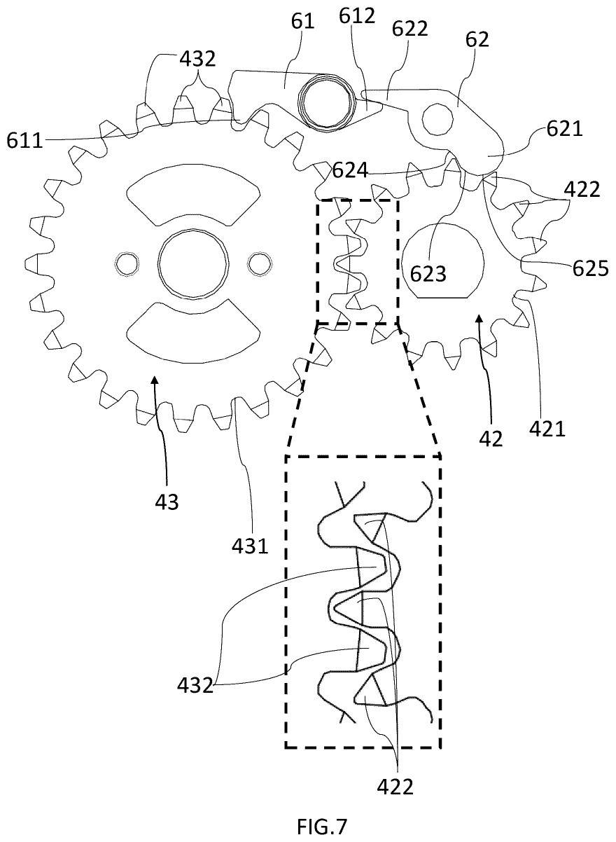

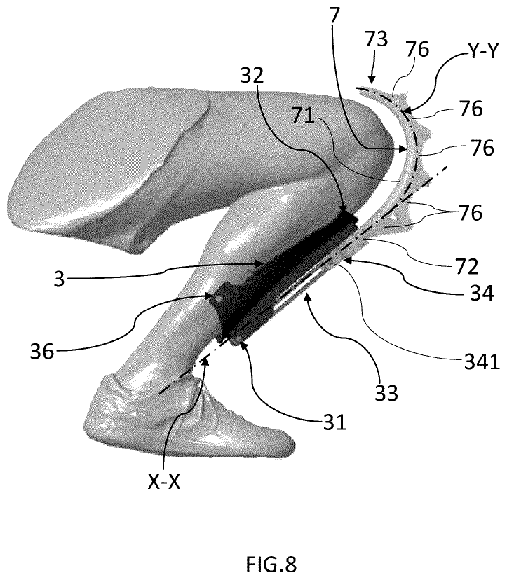

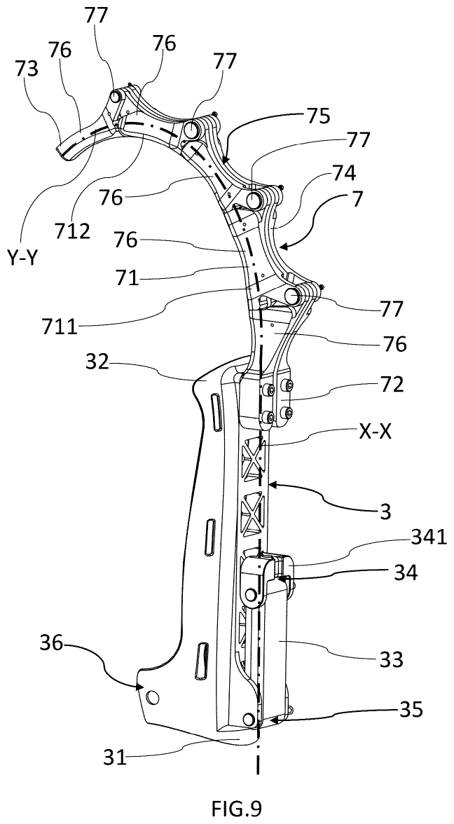

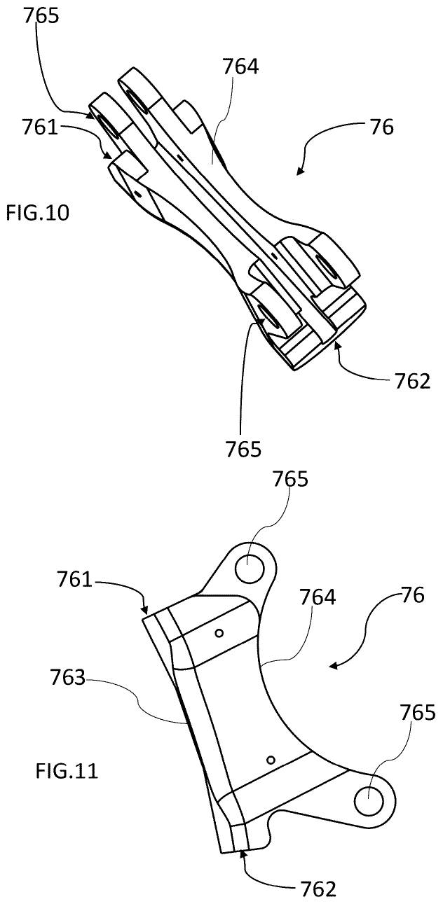

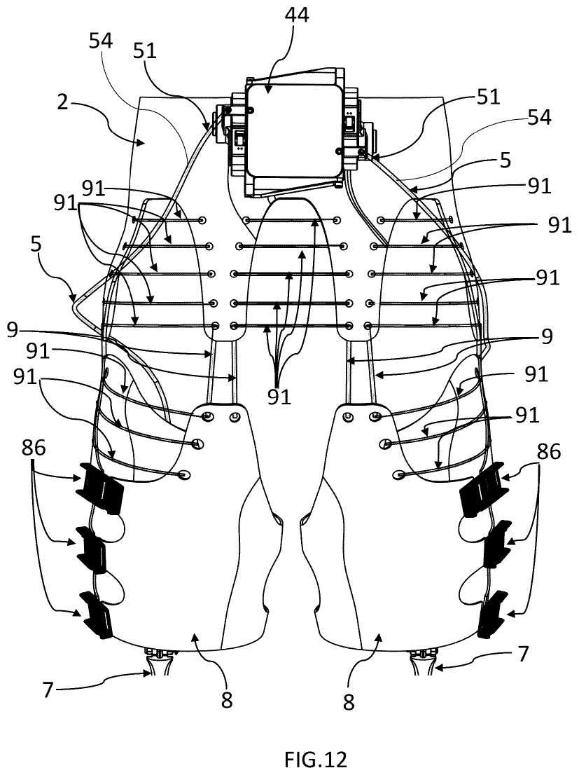

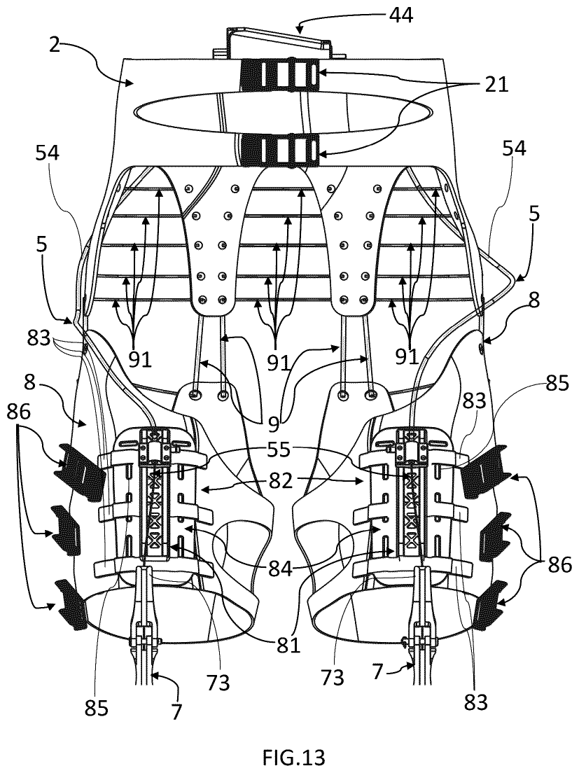

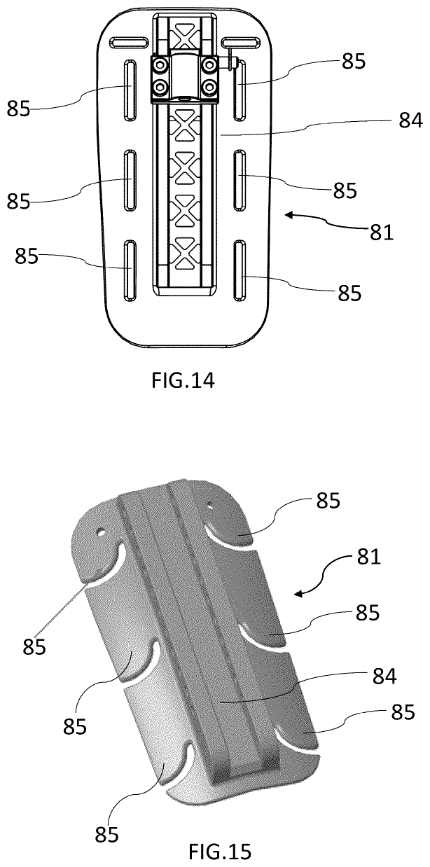

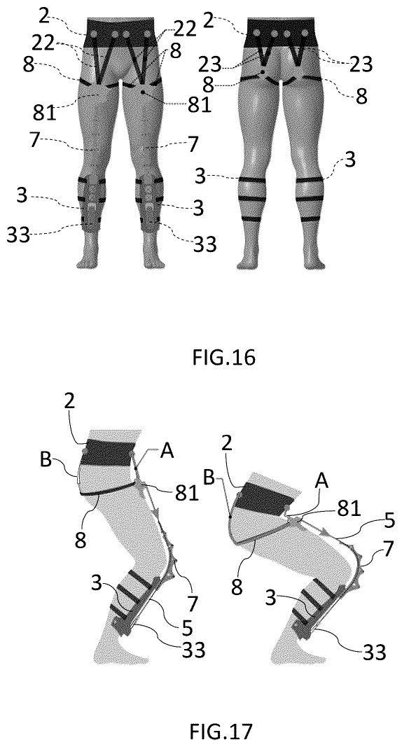

According to the preferred embodiment of the invention, the stopper 61 and the lever 62 have the shape reported in FIG. 6. The shape of the stopper 61 and the lever 62 is partially visible also in FIG. 5.

According to the preferred embodiment of the invention, the actuator 4 comprises a control unit in signal communication with the driver 41 and with an external device. The control unit is configured to switch the driver 41 between the idle state and the working state upon receival of a command signal by the control unit coming from the external device. In other words, it is possible to actively control the driver 41 so that the tension force is transmitted to the calf garment 3 by means of an external device, assisting the user knee movement.

According to the invention, the assistive device 1 comprises a chain 7. Preferably, the chain 7 is interposed between the waist garment 2 and the calf garment 3. Still preferably, when a user is wearing the assistive device 1, the chain is arranged on a front side of the user. As it per se known to the skilled person, the front side of a user is opposite to the back side of the user.

The chain 7 comprises a modular body 71 having a fixed end 72, attached to the calf garment 3, a free end 73 and an upper surface 74 connecting the fixed end 72 and the free end 73. Preferably, the free end 73 is facing the waist garment 2. When a user is wearing the assistive device 1, the upper surface is facing away with respect to the leg of the user.

The modular body 71 comprises a groove 75 defined on the upper surface 74. The transmission cable 5 is slidably channeled in the groove 75. Preferably, only the inner cable 55 of the transmission cable 5 is slidably channeled in the groove 75. Being the transmission cable 5 slidably channeled in the groove 75, the transmission cable 5 can transmit the tension force to the calf garment 3.

The chain 7 is configured to switch between a an initial configuration and a limiting configuration.

In the initial configuration of the chain 7, the fixed end 72 and the free end 73 of the modular body 71 are at a first distance. Preferably, the first distance is the maximum distance between the fixed end 72 and the free end 73.

In the limiting configuration of the chain, the modular body 71 is arranged along a curvature direction Y-Y defining a curvature angle with respect to the longitudinal direction X-X such that the fixed end 72 and the free end 73 of the modular body 71 are at a second distance. The second distance is smaller than the first distance. Namely, when the chain 7 is in the limiting configuration the fixed end 72 and the free end 73 are spaced apart from each other along the curvature direction Y-Y. Preferably, the second distance is the minimum distance between the fixed end 72 and the free end 73.

The bending of the user knee switches the modular body 71 of the chain 7 between the initial configuration and the limiting configuration. In other word, the modular body 71 of the chain 7 follows the bending of the knee of the user wearing the assistive device 1.

It should be noted that, preferably, when a user is wearing the assistive device 1 and the chain 7 is switched from the initial configuration to the limiting configuration it means that the user is assisted in moving from a stand up position to a bent position. At the same time, still preferably, when the user is wearing the assistive device 1 and the chain 7 is switched from the limiting configuration to the initial configuration it means that the user is assisted in moving from a bent position to a stand up position.

It should be noted that, given that the chain 7 guides the transmission cable 5 during the knee movement, the chain 7 avoids applying any force directly on the knee joint of the user wearing the assistive device 1. Therefore, the chain 7 avoids interferences and discomfort during use of the assistive device 1.

At the same time, the chain 7 generates a fully deterministic assistive torque, due to the switching of the chain 7 from the initial configuration to the limiting configuration that permits to route the transmission cable 5 along a desired path around the knee joint of the user wearing the assistive device 1.

Therefore, the chain 7 is used to guide the transmission cable 5 and optimize the moment arm to generate the desired assistive torque and knee flexion angle profile. In order words, the chain 7 contributes in assisting the user knee movement.

According to the preferred embodiment of the invention, the modular body 71 of the chain 7 comprises at least one modular unit. Each modular unit comprises a first and a second rigid elements 76 connected together to define, at least in part, the groove 75 of the modular body 71. Preferably, each rigid element 76 comprises a respective portion of the groove 75 of the modular body 71 and the joining of all said portions defines the groove 75.

Preferably, the modular body 71 comprises five rigid elements 76 arranged in four modular units. In fact, if a rigid element 76 is interposed between other two rigid elements 76, it belongs to two different modular units. In other words, if a rigid element 76 is interposed between other two rigid elements 76, said rigid element 76 defines a first modular unit, wherein it works as a second rigid element 76, with the preceding rigid element 76, and it defines a second modular unit, wherein it works as first rigid element 76, with the succeeding rigid elements 76. Namely, each rigid element 76 defines a respective modular unit with each adjacent rigid element 76.

Still preferably, each rigid element 76 is arranged along the curvature direction Y-Y and extends between a first edge 761 and an opposite second edge 762 with respect to the curvature direction Y-Y.

The first and the second rigid elements 76 of each modular unit are connected together such that in the initial configuration of the chain 7 the second edge 762 of the first rigid element 76 and the first edge 761 of the second rigid element 76 are facing together and spaced apart from each other. Namely, being the second edge 762 of the first rigid element 76 and the first edge 761 of the second rigid element 76 spaced apart from each other in the initial configuration of the chain 7, the fixed end 72 and the free end 73 of the modular body 71 are, preferably, at the maximum distance between each other.

At the same time, the first and the second rigid elements 76 of each modular unit are connected together such that in the limiting configuration of the chain 7 the second edge 762 of the first rigid element 76 and the first edge 761 of the second rigid element 76 are in contact making the modular body 71 of the chain 7 to be arranged along the curvature direction Y-Y. In fact, given that each rigid element is arranged along the curvature direction Y-Y, in the limiting configuration also the whole modular body 71 defined by the rigid elements 76 is arranged along the curvature direction Y-Y.

Therefore, switching from the initial configuration to the limiting configuration the fixed end 72 and the free end 73 of the modular body 71 progressively approaching to reach the minimum distance at the limiting configuration.

Accordingly to the preferred embodiment of the invention, each rigid element 76 extends between a base 763 and an opposite top 764 with respect to a direction transverse to the curvature direction Y-Y.

In addition, each rigid element 76 has at least one through hole 765 placed near the top 764. Preferably, each rigid element 76 has one trough hole 765 for each modular unit to which it belongs. Still preferably, the through holes 765 of each rigid element 76 are placed above the respective portion of the groove 75 of said rigid element 76.

Moreover, preferably, the chain 7 comprises one pin 77 for each modular unit. Each pin 77 is inserted in the through holes 765 of the first and second rigid elements 76 of a respective modular unit connecting the first and second rigid elements 76 of said modular unit together. Namely, the first and second rigid elements 76 of each modular units are hinged together at a connection point resulting from the overlapping of the through holes 765 of the first and second rigid elements 76 of said modular unit.

It should be noted that during the switching from the initial configuration to the limiting configuration of the chain 7, the first and the second rigid elements 76 of each respective modular unit are approaching each other by rotating around their respective connection point.

According to the preferred embodiment of the invention, the modular body 71 of the chain 7 comprises a first portion 711 placed near the fixed end 72 and a second portion 712 placed near the free end 73.

Preferably, the first portion 711 of the chain 7 is arranged along a portion of an ellipse and the second portion 712 of the chain 7 is arranged along a portion of a circle internally tangent to the ellipse in a tangent point when the chain 7 is in the limiting configuration. Given this specific arrangement of the first 711 and second 712 portions of the chain 7, there is no interaction between the human knee and the chain 7.

It should also be noted that, by changing the parameters of the ellipse and of the circle internally tangent to the ellipse, different profiles of the chain 7 in the limiting configuration can be obtained. By changing the profile of the chain 7 in the limiting configuration, the performance of the assistive device 1 can be optimized and, at the same time, it can be adapted to different users.

According to the preferred embodiment of the invention, the calf garment 3 extends between a bottom portion 31 and an opposite top portion 32 along the longitudinal direction X-X. When a user is wearing the assistive device 1, the bottom portion 31 of the calf garment 3 is placed near the ankle of the user.

Preferably, the calf garment 3 comprises an elastic element 33 extending between a first end 34 and an opposite second end 35 along the longitudinal direction X-X. For example, the elastic element 33 is a rubber belt. Still preferably, when a user is wearing the assistive device 1, the elastic element is arranged on the front side of a user.

Still preferably, the transmission cable 5 is connected to the first end 34 of the elastic element 33. More preferably, the lower end 52 of the transmission cable 5 is connected to the first end 34 of the elastic element 33. For example, the first end 34 of the elastic element 33 comprises an end connector 341. It should be noted that, preferably, the lower end 52 of the transmission cable 5 is defined on its inner cable 55. At the same time, preferably, the upper end 51 of the transmission cable 5 is defined on its inner cable 55.

Preferably, the second end 35 of the elastic element 33 is connected to the bottom portion 31 of the calf garment 3. Namely, the elastic element 33 connects the lower end 52 of the transmission cable 5 to the bottom portion 31 of the calf garment 3.

Still preferably, the fixed end 72 of the modular body 71 of the chain 7 is attached to the top portion 32 of the calf garment 3.

According to a preferred feature, the elastic element 33 is configured to switch between a rest configuration and an extended configuration, the distance between the first 34 and the second 35 ends along the longitudinal direction X-X increasing from the rest configuration to the extended configuration.

As already described, the actuator 4 is configured to transform the rotational force of the driver 41 in a first tension force, acting as a pull force, and in a second tension force, acting as a releasing force. The first tension force transmitted to the calf garment 3 is configured to switch the elastic element 33 from the rest configuration to the extended configuration. At the same time, the second tension force transmitted to the calf garment 3 is configured to allow the elastic element 33 to switch from the extended to the rest configuration due to the elastic return of the elastic element 33.

It should be noted that, preferably, as the tension force generated by the actuator 4 switch the elastic element 33 from the rest to the extend configuration and as the user wearing the assistive device 1 switches from a stand up position to a bent position, the chain 7 is simultaneously switched from the initial configuration to the limiting configuration. At the same time, as the tension force generated by the actuator 4 allow the elastic element 33 to switch from the extended configuration to the rest configuration and as the user wearing the assistive device 1 switches from a bent position to a stand up position, the chain 7 is simultaneously switched from the limiting configuration to the initial configuration.

It should be also noted that, when a user is wearing the assistive device 1 and the elastic element 33 is in the rest configuration the user is in a stand up position. On the other hand, when the elastic element 33 is in the extended configuration the user is in a bent position. In other word, by switching the elastic element 33 from the rest configuration to the extended configuration and viceversa, the user is assisted in doing, for example, a squat.

According to the preferred embodiment of the invention, the assistive device 1 comprises a thigh garment 8 attachable to a user thigh. For example, the thigh garment 8 comprises at least one second buckle 86. Preferably, the thigh garment 2 comprises three second buckles 86. As is per se know to the skilled person, the second buckles 86 allows the thigh garment 8 to be stably attached to a user thigh. At the same time, the second buckles 86 allows to adjust the thigh garment 8 according to the specific dimension of the user thigh, increasing the comfort of the user wearing said thigh garment 8.

As the thigh garment 8 is attachable to a user thigh, when the user is wearing the assistive device 1, the thigh garment 8 is interposed between the waist garment 2 and the calf garment 3.

Preferably, the thigh garment 8 comprises a support element 81. When a user is wearing the thigh garment 8, the support element 81 is placed on the front side of a user.

The transmission cable 5 is slidably channeled in the support element 81. Advantageously, the support element 81 of the thigh garment allows a better transmission of the tension force generated by the actuator 4 to the calf garment 3.

Preferably, the cover housing 54 of the transmission cable 5 connects the box 44 to the support element 81. In other word, preferably, the inner cable 55 of the transmission cable 5 is channeled in the cover housing 54 only between the box 44 and the support element 81.

Still preferably, the free end 73 of the modular body 71 of the chain 71 faces the thigh garment 8. Namely, the chain 7 is configured to be interposed between the thigh garment 8 and the calf garment 3.

According to the preferred embodiment of the invention, the thigh garment 8 comprises a body portion 82 having a plurality of first joining elements 83. Preferably, the support element 81 comprises a plate 84 having a plurality of second joining elements 85. Each second joining element 85 is connected to a respective first joining element 83 to stably attach the support element 81 to the body portion 82 of the thigh garment 8. By disconnecting the second joining elements 85 and the first joining elements 83 it is possible to remove the support element 81 from the body portion 82 of the thigh garment 8.

For example, each first joining element 83 correspond to a strap or a belt, while each second joining element 85 corresponds to a fin insertable in a respective strap or a slot configured to receive a respective belt.

Still according to the preferred embodiment of the invention, the assistive device 1 comprises a plurality of first elastic robs 9 connecting the waist garment 2 to the thigh garment 8. Therefore the first elastic robs 9 prevents the sliding down of the thigh garment 8 with respect to the waist garment 2 during the use of the assistive device 1. Therefore, the first elastic robs 9 increase the comfort of a user wearing the assistive device 1.

According to the preferred embodiment of the invention, both the waist garment 2 and the thigh garment 8 comprises a plurality of respective second elastic robs 91. Each second elastic rob 91 is disposed transversally to the first elastic robs 9. It should be noted that the second elastic rob 91 of the waist garment 2 are used to maintain the shape of the waist garment 2 when a user is wearing the assistive device 1. At the same time, the second elastic rob 91 of the thigh garment 8 are used to maintain the shape of the thigh garment 8 when a user is wearing the assistive device 1.

According to a preferred embodiment, the assistive device comprises first straps 22 and second straps 23 connecting the waist garment 2 to the thigh garment 8. Preferably, when a user is wearing the assistive device 1 the first straps 22 are arranged on the front side of the user, while the second straps 23 are arranged on the back side of the user. Both the first straps 22 and the second straps 23 are arranged in a triangular shape, with one attachment point on the thigh garment 8 and two attachments points on the waist garment 2.

It should be noted that, the first straps 22 defines a first trace A for the load distribution, while the second straps 23 together with the thigh garment 8 defines a second trace B for the load distribution. Advantageously, the first 22 and second 23 straps can provide a stable support for the transmission cable 5 and distribute the high tension force to the upper thigh and hip of the user wearing the assistive device 1. For example, if a user wearing the assistive device 1 is performing a squat motion, the load distribution switches between the first trace A and a second trace B.

At the beginning of squat, the first trace A will deliver the load to the waist garment 2 while the second trace B is loose. With the increase of the squat depth, the first trace A gradually becomes loose and the tension load will deliver to the backside of the waist garment 2 via the second trace B that has the additional benefit of also generating a positive torque around the hip supporting this joint during deep squat and during the transition from a squat to a standing posture.

It is also an object of the present invention, an exoskeleton comprising two assistive devices 1 corresponding to the assistive device 1 described above. Each assistive device 1 of the exoskeleton is used to assist the movement of a corresponding user knee.

Preferably, the actuator 41 of the two assistive devices 1 are arranged in the same box 44. Still preferably, the waist garment 2 can be the same for both assistive devices 1 of the exoskeleton.

1. A knee movement assistive device, comprising:
a waist garment attachable to a user waist and a calf garment attachable to a user calf, said calf garment being arranged along a longitudinal direction;
an actuator attached to the waist garment and comprising a driver, said driver being configured to switch between an active state, wherein the driver generates a rotational force, and an idle state, wherein the driver generates a null force, the actuator being configured to transform the rotational force of the driver in a tension force;
a transmission cable connecting the actuator to the calf garment and being configured to transmit the tension force, generated by transforming the rotational force of the driver, to the calf garment;
said assistive device being configured in that it comprises:
a chain comprising a modular body having a fixed end, attached to the calf garment, a free end and an upper surface connecting the fixed end and the free end, said modular body comprising a groove defined on said upper surface, the transmission cable being slidably channeled in said groove;
and wherein:
the chain is configured to switch between an initial configuration, wherein the fixed end and the free end of the modular body are at a first distance, and a limiting configuration, wherein the modular body is arranged along a curvature direction defining a curvature angle with respect to the longitudinal direction such that the fixed end and the free end of the modular body are at a second distance, said second distance being smaller than the first distance, the bending of the user knee switching the modular body of the chain between the initial configuration and the limiting configuration.

2. Assistive device according to claim 1, wherein the modular body of the chain comprises at least one modular unit, each modular unit comprising a first and a second rigid elements connected together to define, at least in part, the groove of the modular body.

3. Assistive device according to claim 2, wherein:
each rigid element is arranged along the curvature direction and extends between a first edge and an opposite second edge with respect to said curvature direction;
the first and the second rigid elements of each modular unit being connected together such that in the initial configuration of the chain the second edge of the first rigid element and the first edge of the second rigid element are facing together and spaced apart from each other while, in the limiting configuration of the chain the second edge of the first rigid element and the first edge of the second rigid element are in contact making the modular body of the chain to be arranged along the curvature direction.

4. Assistive device according to claim 3, wherein:
each rigid element extends between a base and an opposite top with respect to a direction transverse to the curvature direction, each rigid element having at least one through hole placed near the top;
the chain comprises one pin for each modular unit;
each pin being inserted in the through holes of the first and second rigid elements of a respective modular unit connecting the first and second rigid elements of said modular unit together.

5. Assistive device according to any claim 1, wherein:
the modular body comprises a first portion placed near the fixed end and a second portion placed near the free end;
said first portion being arranged along a portion of an ellipse and said second portion being arranged along a portion of a circle internally tangent to the ellipse in a tangent point when the chain is in the limiting configuration.

6. Assistive device according to claim 1, wherein:
the calf garment extends between a bottom portion and an opposite top portion along the longitudinal direction, said calf garment comprising an elastic element extending between a first end and an opposite second end along the longitudinal direction, the transmission cable being connected to the first end of the elastic element, the second end of the elastic element being connected to the bottom portion of the calf garment, said elastic element being configured to switch between a rest configuration and an extended configuration, the distance between the first and the second ends along the longitudinal direction increasing from the rest configuration to the extended configuration;
the actuator is configured to transform the rotational force of the driver in a first tension force, acting as a pull force, and in a second tension force, acting as a releasing force; the first tension force transmitted to the calf garment being configured to switch the elastic element from the rest configuration to the extended configuration, the second tension force transmitted to the calf garment being configured to allow the elastic element to switch from the extended to the rest configuration due to the elastic return of the elastic element.

7. Assistive device according to claim 6, wherein:
the fixed end of the modular body of the chain is attached to the top portion of the calf garment.

8. Assistive device according to claim 1, comprising a thigh garment attachable to a user thigh, said thigh garment comprising a support element, the transmission cable being slidably channeled in said support element, the free end of the modular body of the chain facing the thigh garment.

9. Assistive device according to claim 8, wherein:
the thigh garment comprises a body portion having a plurality of first joining elements;
the support element comprising a plate having a plurality of second joining elements, each second joining element being connected to a respective first joining element to stably attach the support element to the body portion of the thigh garment.

10. Assistive device according to claim 7, comprising a plurality of first elastic robs connecting the waist garment to the thigh garment.
